(19) United States
(12) Patent Application Publication
(10) Pub. No.: US 2017/0306869 A1
(43) Pub. Date: Oct. 26, 2017

(54) DIESEL ENGINE AND METHOD FOR STARTING A DIESEL ENGINE

(71) Applicant: MTU FRIEDRICHSHAFEN GMBH, Friedrichshafen (DE)

(72) Inventors: Christoph LUCKAS, Kressbronn (DE); Wolfgang FIMML, Hörbranz (AT); Johannes SCHALK, Friedrichshafen (DE); Jonathan LIPP, Friedrichshafen (DE)

(21) Appl. No.: 15/516,256

(22) PCT Filed: Nov. 30, 2015
(86) PCT No.: PCT/EP2015/002405

§ 371 Date: Mar. 31, 2017

(30) Foreign Application Priority Data
Jan. 13, 2015 (DE) 102015000433.6

(51) Int. Cl. F02D 41/00; F02D 41/04; F02D 41/06; F02D 13/02

(52) U.S. Cl. CPC F02D 41/0077; F02D 41/064; F02D 41/0062; F02D 13/0269; F02D 41/04; F02D 2041/001; F02D 2041/0092

(57) ABSTRACT

A diesel engine, in particular a high-power diesel engine, which has a variable valve train including an adjusting unit for adjusting a valve opening time, a valve lift, a camshaft phase position and/or a valve steering, and a control or regulating unit for controlling the adjusting unit. The control and/or regulating unit includes at least one operational mode provided for starting the engine when the engine is at a low temperature, in which the control and/or regulating unit is provided to adjust the valve opening time, at least during a preliminary phase for at least one inlet valve, which overlaps at least with one compression stroke of an associated cylinder, and to interrupt an injection of fuel at least into the cylinder associated with the inlet valve. The invention also relates to a method for starting such a diesel engine.

The invention relates to a diesel engine, in particular a high-power diesel engine, and to a method for starting a diesel engine, in particular a method for starting a high-power diesel engine.

Diesel engines tend to exhibit poor starting behavior in the presence of cold ambient conditions. To improve the starting behavior, it is known for additional charge-air heaters to be provided. Likewise known are systems which permit a variation of a geometrical compression ratio.

The invention is based in particular on the object of providing a diesel engine with improved starting behavior in the presence of low engine temperatures, and of improving a method for starting a diesel engine in the presence of low engine temperatures. Said object is achieved by means of a diesel engine according to the invention corresponding to claim 1 and by means of a method according to the invention corresponding to claim 9. Refinements of the invention will emerge from the dependent claims.

The invention relates to a diesel engine, in particular a high-power diesel engine, having a variable valve drive which has an adjustment unit for adjustment of a valve opening time, of a valve lift, of a camshaft phase angle and/or of a valve spread, and having an open-loop and/or closed-loop control unit for the activation of the adjustment unit, wherein the open-loop and/or closed-loop control unit has at least one operating mode provided for engine starting in the presence of low engine temperatures, in which operating mode the open-loop and/or closed-loop control unit is provided so as, at least during a pre-running phase, to set for at least one inlet valve a valve opening time which at least overlaps a compression stroke of an associated cylinder, and to prevent an injection of fuel. By virtue of the fact that the inlet valve has a valve opening time which overlaps the compression stroke, and the open-loop and/or closed-loop control unit prevents the injection of fuel, combustion air that has previously been drawn in is displaced back into an intake tract of the diesel engine again and is drawn in again in a following cycle. In this way, it is possible to realize a repeated charge exchange between the intake tract and the cylinder, by means of which the combustion air can be preheated without an additional module for charge-air heating or the like having to be installed for this purpose. In particular, white-smoke formation occurring in the presence of low engine temperatures can be advantageously reduced by means of the proposed refinement, as a result of which the operating mode is suitable for engine starting in the presence of low engine temperatures. A “variable valve drive” is to be understood in particular to mean a valve drive which is provided for setting at least two different valve opening times, and/or different valve lifts, for an inlet valve and/or an outlet valve. A “valve opening time” of an inlet valve is to be understood in particular to mean an angle range in which the inlet valve or outlet valve is open, wherein an “angle range” is understood in particular to mean an angle range relating to a camshaft angle or a crankshaft angle. A “camshaft angle” is to be understood in particular to mean a rotational angle position of a camshaft relative to a defined zero point, for example at the start of a combustion cycle. A “crankshaft angle” is to be understood in particular to mean a rotational angle position of a crankshaft relative to the same defined zero point as the camshaft angle. A “valve lift” is to be understood in particular to mean an opening travel of the corresponding inlet valve during an actuation by the camshaft. A “spread” is to be understood in particular to mean an angular interval between an angular position at which the inlet valve is open to a maximum extent and an angular position at which an outlet valve of the same cylinder is open to a maximum extent. An “open-loop and/or closed-loop control unit” is to be understood in particular to mean a unit with at least open-loop control electronics. “Open-loop control electronics” are to be understood in particular to mean a unit having a processor unit and having a memory unit and having an operating program stored in the memory unit. “Provided” is to be understood in particular to mean specially programmed, configured and/or equipped. An “engine temperature” is to be understood here, and below, in particular to mean a temperature value relating to an operating medium, such as for example a cooling water temperature or an engine oil temperature. A “low engine temperature” is to be understood in particular to mean an engine temperature lying below a normal operating temperature. A “normal operating temperature” is to be understood in particular to mean a value for the engine temperature to which the engine temperature is adjusted by closed-loop control during continuous operation. A “cycle” is to be understood in particular to mean a four-stroke cycle with an intake stroke, a compression stroke, a working stroke and an exhaust stroke. An “intake stroke” is to be understood in particular to mean a stroke in which a piston of the corresponding cylinder is moved from a top dead center in the direction of a bottom dead center in order to draw combustion air out of the intake tract. A “compression stroke” is to be understood in particular to mean a stroke which follows the intake stroke and in which the piston of the corresponding cylinder is moved from the bottom dead center in the direction of the top dead center in order to compress an air-fuel mixture in the cylinder. A “working stroke” is to be understood in particular to mean a stroke which follows the compression stroke and in which the piston of the corresponding cylinder is moved from the top dead center in the direction of the bottom dead center, wherein, during the working stroke, a combustion gas performs mechanical work on the piston. An “exhaust stroke” is to be understood in particular to mean a stroke which follows the working stroke and in which the piston of the corresponding cylinder is moved from the bottom dead center in the direction of the top dead center in order to displace the combustion gas, as exhaust gas, out of the cylinder. A “pre-running phase” is to be understood in particular to mean a phase of the engine starting extending up until initial ignition of the diesel engine.

The open-loop and/or closed-loop control unit is preferably provided so as to prevent the injection of fuel for at least one cycle. If the injection is prevented for at least one entire cycle, each cylinder of the diesel engine is assigned at least one compression stroke, whereby, for each cylinder, a charge exchange between the associated combustion chamber and the intake stroke can be realized, which preheats the combustion air for the corresponding cylinder.

Furthermore, the open-loop and/or closed-loop control unit may be provided so as, only for the engine starting, to set for the at least one inlet valve a valve opening time which overlaps both the intake stroke and the compression stroke of the associated cylinder. By means of the valve opening time which overlaps the intake stroke and the compression stroke, it is possible to realize a particularly intensive charge exchange between the cylinder and the intake tract, and it is possible to realize good heating of the combustion air for the engine starting. Furthermore, such an adjustment can be easily realized, whereby the adjustment unit can be of particularly simple form. At the same time, for operation of the diesel engine, valve opening times can be selected which make it possible to realize higher rated power and/or lower fuel consumption. In the following exemplary embodiment, the adjustment unit is described as a lift-switching means with different cam curves. It is alternatively also conceivable for the adjustment unit to be realized by means of a camshaft adjuster with an adequately large adjustment range. Likewise conceivable is a refinement of the adjustment unit with a hydraulic coupling between the camshaft and the inlet valves, wherein the actuator arrangement is provided for varying a coupling between the camshaft and the gas exchange valves. A “valve opening time which overlaps the intake stroke and the compression stroke” is to be understood in this context to mean in particular that the inlet valve has a valve opening time which lies within the intake stroke and has a valve closing time which lies within the compression stroke, whereby the inlet valve is open for at least a part of the intake stroke and at least a part of the compression stroke.

In particular, the open-loop and/or closed-loop control unit may be provided so as to set the pre-running phase for at least two cycles. By virtue of the pre-running phase extending over multiple cycles, it is possible to realize particularly good heating of the combustion air. As a result of the good heating, the ignition behavior can be influenced in a particularly advantageous manner. It is basically possible here for the charge exchange to be realized in a two-stroke cycle. It is however also conceivable for the inlet valves to be actuated in a four-stroke cycle, as is provided for the operation of the diesel engine.

It is furthermore proposed that the open-loop and/or closed-loop control unit is provided so as, in the operating mode, to activate the injection of fuel for an ignition phase for the ignition of an air-fuel mixture in the cylinders. By virtue of the ignition phase being predefined through activation of the injection of fuel, a time of the first ignition can be well defined. In particular, if the activation of the injection is dependent on further parameters, such as for example the engine temperature and/or an ambient temperature, the open-loop and/or closed-loop control unit may have, for the operating mode, a characteristic map and/or a characteristic curve by means of which the parameters can be taken into consideration. Here, an “ignition phase” is to be understood in particular to mean a phase of the engine starting extending from the initial ignition to a point at which an idle rotational speed is attained. Here, a “time” is to be understood in particular to mean a time defined by a crankshaft angle.

The adjustment unit may be provided so as to set for the at least one inlet valve assigned to the cylinder a valve opening time which is provided for operation in accordance with a Miller cycle. In this way, a normal operating mode can be realized in which the diesel engine exhibits high efficiency and at the same time exhibits good engine starting behavior in the presence of low engine temperatures. Here, “operation in accordance with a Miller cycle” is to be understood in particular to mean that the valve opening time completely overlaps the exhaust stroke and/or the intake stroke of the cylinder assigned to the inlet valve. In this context, “completely” is to be understood in particular to mean that the at least one inlet valve opens during the exhaust stroke or the intake stroke and closes during the intake stroke. In particular, this is to be understood to mean that the valve opening time does not overlap the compression stroke or the working stroke.

Furthermore, the open-loop and/or closed-loop control unit may be provided so as, during the ignition phase, to set the valve opening time provided for operation in accordance with the Miller cycle. In this way, a particularly early switch to the valve opening times provided for the normal operating mode can be realized. By virtue of the diesel engine being provided for being operated in a normal operating mode in accordance with the

Miller cycle, it is possible in particular to realize an increase in power using simple means. By means of the operating mode, the engine starting in the presence of low operating temperatures can be ensured.

The diesel engine may basically have cylinders with any desired cylinder power and/or with any desired swept volume. The diesel engine preferably has a cylinder power of at least 50 kW and/or a swept volume of at least 1.6 l. In particular in the case of diesel engines which are configured for a high level of power and which have a correspondingly large total cylinder volume, it is possible by means of adjustment of the valve drive to achieve good starting behavior in the presence of low engine temperatures. Here, a “cylinder power” is to be understood to mean a power of the diesel engine per cylinder. A “total cylinder volume” is to be understood to mean a volume of the combustion chamber before a compression, that is to say when the corresponding piston is at a bottom dead center. By contrast, a “compression volume” is to be understood in particular to mean a volume of the combustion chamber after a compression, that is to say when the corresponding piston is at a top dead center. A “swept volume” is to be understood in particular to mean a volume which is defined by a piston cross-sectional area and the piston stroke. The swept volume thus corresponds to the total cylinder volume minus the compression volume.

Furthermore, a method for starting a diesel engine is proposed, in particular a method for starting a high-power diesel engine, in which method an open-loop and/or closed-loop control unit, in an operating mode provided for engine starting in the presence of low engine temperatures, at least during a pre-running phase, sets for at least one inlet valve a valve opening time which at least overlaps a compression stroke of an associated cylinder, and prevents an injection of fuel at least in the cylinder assigned to the inlet valve.

Further advantages will emerge from the following FIGURE description. The single FIGURE illustrates an exemplary embodiment of the invention. The FIGURE, the FIGURE description and the claims encompass numerous features.

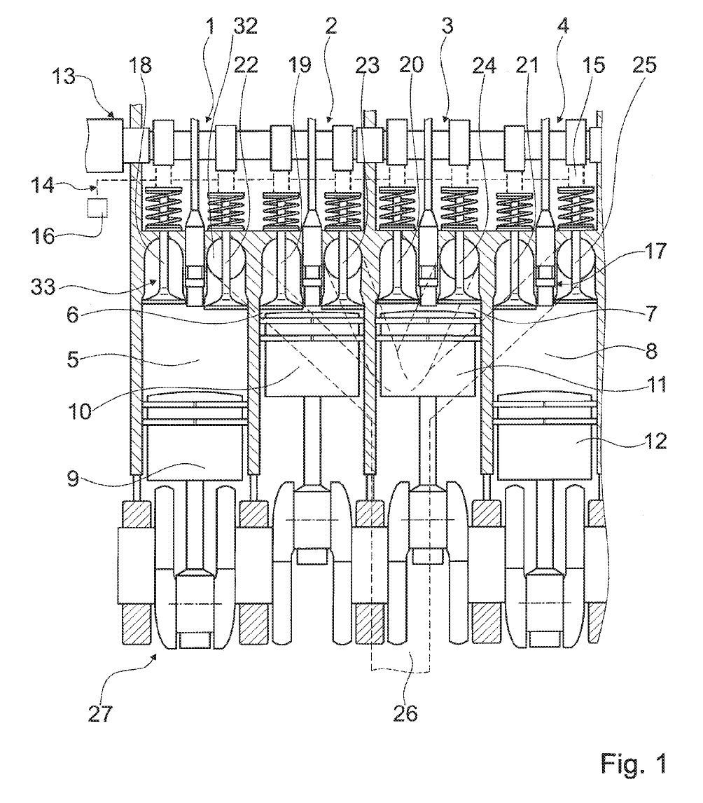

FIG. 1 schematically shows a diesel engine which is basically suitable for use in heavy agricultural vehicles, in rail vehicles or in watercraft. The diesel engine comprises multiple cylinders 1, 2, 3, 4 which have in each case one combustion chamber 5, 6, 7, 8, for the combustion of an air-fuel mixture, and a piston 9, 10, 11, 12 guided in the combustion chamber 5, 6, 7, 8. The diesel engine comprises, for each cylinder 1, 2, 3, 4, at least one injector 17 which is provided for introducing fuel into the combustion chamber 5, 6, 7, 8 of the respective cylinder 1, 2, 3, 4. For the sake of simplicity, in FIG. 1, only one of the injectors 17 is provided with a reference designation. The cylinders 1, 2, 3, 4 comprise in each case one or more inlet valves 18, 19, 20, 21 and one or more outlet valves 22, 23, 24, 25. The inlet valves 18, 19, 20, 21 are provided for supplying combustion air from an intake tract 33 to the combustion chamber 5, 6, 7, 8 of the corresponding cylinder 1, 2, 3, 4. The intake tract 33 comprises a unit (not illustrated in any more detail) for increasing charge pressure, such as for example an exhaust-gas turbocharger. The fuel is injected into the combustion air in the combustion chamber 5, 6, 7, 8. As a result of compression, the air-fuel mixture in the combustion chamber 5, 6, 7, 8 is ignited. Via the outlet valves 22, 23, 24, 25, an exhaust gas which is generated as a result of combustion of the air-fuel mixture is supplied to an exhaust-gas system 26. For the actuation of the inlet valves 18, 19, 20, 21 and of the outlet valves 22, 23, 24, 25, the diesel engine comprises a variable valve drive 13 with at least one camshaft 32 which, in the exemplary embodiment illustrated, for the sake of simplicity of the drawing, is illustrated as a combined inlet and outlet camshaft. It is basically also conceivable for separate camshafts to be provided for the inlet valves 18, 19, 20, 21 and the outlet valves 22, 23, 24, 25.

The diesel engine is designed as a fast-running diesel engine. In the exemplary embodiment illustrated, the diesel engine has an idle rotational speed of approximately 600 rpm. A maximum rotational speed is approximately 2200 rpm in the exemplary embodiment illustrated. Each combustion chamber 5, 6, 7, 8 of the diesel engine has a cylinder volume of 4.77 l. A cylinder power of the diesel engine is approximately 150 kW.

Depending on the type of construction, the diesel engine may have between 8 and 20 cylinders 1, 2, 3, 4. The diesel engine is thus provided for a power of between 1200 kW and 3000 kW. The diesel engine may however in principle also have other engine data.

Furthermore, the diesel engine comprises a crankshaft 27. The cylinders 1, 2, 3, 4 comprise in each case one connecting rod which connects the piston 9, 10, 11, 12 of the corresponding cylinder 1, 2, 3, 4 to the crankshaft 27. The camshaft 32 comprises a multiplicity of cams for the actuation of the inlet valves 18, 19, 20, 21 and of the outlet valves 22, 23, 24, 25. Each of the cams is assigned to exactly one of the inlet valves 18, 19, 20, 21 or one of the outlet valves 22, 23, 24, 25. Each of the cams has a cam curve which defines a valve opening time and a valve lift for the inlet valve 18, 19, 20, 21 or outlet valve 22, 23, 24, 25 assigned to the cam. A relative rotational angle interval between the cams provided for the inlet valves 18, 19, 20, 21 and the cams provided for the outlet valves 22, 23, 24, 25 defines a valve spread. In an embodiment in which the camshaft 32 is designed as an inlet camshaft, the camshaft 32 has only cams for actuating the inlet valves 18, 19, 20, 21. The valve spread is then dependent on an angular offset of the cams arranged on the camshaft designed as inlet camshaft and the cams arranged on the camshaft designed as outlet camshaft.

For the adjustment of the valve opening times, of the valve lift and/or of the valve spread, the valve drive 13 is configured to be variable. The valve drive 13 comprises an adjustment unit 14 which is provided for varying valve opening times and/or valve lifts of the inlet valves 18, 19, 20, 21 and/or the valve spread between the inlet valves 18, 19, 20, 21 and the outlet valves 22, 23, 24, 25 of a cylinder 1, 2, 3, 4. For the adjustment of the valve drive 13, the adjustment unit 14 has an actuator arrangement 15. In the exemplary embodiment illustrated, the actuator arrangement 15 comprises one actuator for each inlet valve 18, 19, 20, 21 and one actuator for each outlet valve 22, 23, 24, 25, wherein, in FIG. 1, for the sake of simplicity, only one of the actuators has been provided with the reference designation of the actuator arrangement 15. The actuators arranged in each case between the camshaft 32 and the associated inlet valve 18, 19, 20, 21 or outlet valve 22, 23, 24, 25 are merely schematically illustrated. The actuator arrangement 15 is provided for individually adjusting each inlet valve 18, 19, 20, 21 and each outlet valve 22, 23, 24, 25. It is alternatively also conceivable for the adjustment unit 14 to be provided for adjusting valve opening times, valve lifts and/or spreads of multiple inlet valves 18, 19, 20, 21 and/or multiple outlet valves 22, 23, 24, 25 jointly, for example by means of an actuator in the form of a camshaft adjuster. It is basically also possible for the valve drive 13 to have other embodiments. In particular, different mechanical, electrical, pneumatic and/or hydraulic configurations of the variable valve drive 13 are conceivable.

The diesel engine has an open-loop and closed-loop control unit 16 which is provided for activating the adjustment unit 14. The open-loop and closed-loop control unit 16 is provided for activating the actuator arrangement 15 of the adjustment unit 14 in a manner dependent on operating parameters of the diesel engine. The open-loop and closed-loop control unit 16 is connected to the actuators of the adjustment unit 14 and provides for these a control signal, in a manner dependent on which the actuators then effect the adjustment of the corresponding inlet valve 18, 19, 20, 21 or outlet valve 22, 23, 24, 25.

In the exemplary embodiment illustrated, the adjustment unit 14 of the diesel engine is in the form of a valve lift switching means. The cams each comprise multiple cam curves. The adjustment unit 14 is provided for coupling the inlet valves 18, 19, 20, 21 to in each case one of the different cam curves of the cam assigned to the corresponding inlet valve 18, 19, 20, 21, whereby at least two different valve actuations can be set for each of the inlet valves 18, 19, 20, 21. In addition or alternatively to the embodiment with multiple cam curves, the actuators may be provided for varying a coupling between the camshaft 32 and the corresponding inlet valve 18, 19, 20, 21 or the outlet valve 22, 23, 24, 25. Depending on a setting of the actuators, the cam curve is converted entirely into an opening of the inlet valve 18, 19, 20, 21 or of the outlet valve 22, 23, 24, 25, or the inlet valve 18, 19, 20, 21 or the outlet valve 22, 23, 24, 25 respectively is only partially open. In the present exemplary embodiment, the adjustment unit 14 is provided in particular for the adjustment of the valve opening times of the inlet valves 18, 19, 20, 21. It is possible for the actuators illustrated in the exemplary embodiment for the adjustment of the outlet valves 22, 23, 24, 25 to be omitted. Some other embodiment of the adjustment unit 14 is basically also conceivable.

In the described exemplary embodiment, each of the actuators comprises two cam followers, wherein each of the cam followers is assigned to one of the cam curves of the corresponding cam. The actuators furthermore comprise at least one hydraulic chamber via which one cam follower or the other cam follower can be selectively coupled to the associated inlet valve 18, 19, 20, 21. Furthermore, the actuator arrangement 15 comprises at least one control valve by means of which an operating medium quantity and/or an operating medium pressure within the hydraulic chambers of the actuators can be varied. The valve lift switching means is controlled through activation of the at least one control valve.

In a normal operating mode, the diesel engine is provided for operation in accordance with the Miller cycle. The crankshaft 27 has a crankshaft angle which, in one cycle of the diesel engine, runs through an angle range from 0 degrees to 720 degrees. The camshaft 32 has a camshaft angle which, in the cycle of the diesel engine, runs through an angle range from 0 degrees to 360 degrees. Since the valve drive 13 has a transmission ratio of 2:1, that is to say two revolutions of the crankshaft 27 correspond to one revolution of the camshaft 32, a camshaft angle of 360 degrees corresponds to a crankshaft angle of 720 degrees.

In the cycle, the pistons 9, 10, 11, 12 run in each case through a top dead center and a bottom dead center. Based on a movement reversal of the pistons 9, 10, 11, 12 at the dead centers, an intake stroke, a compression stroke, a working stroke and an exhaust stroke are defined for each cylinder 1, 2, 3, 4 in the cycle of the diesel engine. Each stroke corresponds to a piston stroke of the corresponding piston 9, 10, 11, 12. During operation of the diesel engine in accordance with the Miller cycle, the inlet valves 18, 19, 20, 21 have a valve opening time which corresponds to a crankshaft angle which is assigned to the exhaust stroke of the corresponding cylinder 1, 2, 3, 4. The valve opening time thus lies before a time at which the corresponding piston 9, 10, 11, 12 passes through the bottom dead center. The inlet valves 18, 19, 20, 21 furthermore have a valve closing time which corresponds to a crankshaft angle which is assigned to the intake stroke of the corresponding cylinder 1, 2, 3, 4. The valve closing time thus lies after a time at which the corresponding piston 9, 10, 11, 12 passes through the bottom dead center. The inlet valves 18, 19, 20, 21 thus open during the exhaust stroke and close during the intake stroke.

The open-loop and closed-loop control unit 16 has an operating mode provided for engine starting in the presence of low engine temperatures. In the operating mode, the open-loop and closed-loop control unit 16 divides the engine starting into a pre-running phase and an ignition phase. The open-loop and closed-loop control unit 16 is provided so as, in the operating mode, through activation of the actuator arrangement 15 of the adjustment unit 14 during the pre-running phase, to set for the inlet valves 18, 19, 20, 21 valve opening times which overlap with the compression stroke of the associated cylinder 1, 2, 3, 4, and to prevent an injection of fuel. The operating mode is in this case provided only for the engine starting. The valve opening times that the open-loop and closed-loop control unit 16 is provided to set in the operating mode are in particular not provided for the normal operating mode.

The open-loop and closed-loop control unit 16 is provided for preventing the injection of fuel for at least one cycle. In particular, the open-loop and closed-loop control unit 16 may be provided for preventing the injection of fuel for multiple cycles. A number of cycles in which the injection of fuel can be stopped during the engine starting may be dependent on various parameters. For example, the open-loop and closed-loop control unit 16 may be provided so as to predefine the number of cycles in which the injection of fuel is prevented in a manner dependent on the engine temperature. Alternatively or in addition, the open-loop and closed-loop control unit 16 may also be provided for preventing the injection of fuel until an engine rotational speed of the diesel engine reaches a starting rotational speed stored in the open-loop and closed-loop control unit 16.

The adjustment unit 14 is provided so as, in the operating mode, to set for the inlet valves 18, 19, 20, 21 valve opening times which overlap both the intake stroke and the compression stroke of the associated cylinder 1, 2, 3, 4. The adjustment unit 14 is provided so as to set for the inlet valves 18, 19, 20, 21 a valve opening time which lies before a time at which the corresponding piston 9, 10, 11, 12 passes through the top dead center, and a valve closing time which lies after a time at which the corresponding piston 9, 10, 11, 12 passes through the top dead center. In this operating mode, the valve opening time corresponds to a crankshaft angle of between 40 degrees and 0 degrees before the top dead center. In this operating mode, the valve closing time corresponds to a crankshaft angle of between 100 degrees and 0 degrees before the bottom dead center.

The operating mode is provided in particular for the starting of the engine. The open-loop and closed-loop control unit 16 is provided so as, only for the engine starting, to set for the inlet valves 18, 19, 20, 21 the valve opening times that overlap the intake stroke and the compression stroke of the associated cylinder 1, 2, 3, 4. Through setting of said valve opening times, the combustion air that is drawn in during the intake stroke is returned into the intake tract 33 again in the compression stroke. The combustion air is thus, in the pre-running phase, displaced back and forth multiple times between the combustion chamber 5, 6, 7, 8 of the corresponding cylinder 1, 2, 3, 4 and the intake tract 33. By virtue of the injection of fuel being prevented in the pre-running phase, the combustion air is merely heated. Only in the ignition phase that follows the pre-running phase is fuel added to the combustion air.

The open-loop and closed-loop control unit 16 is provided for setting the pre-running phase for at least two cycles. The injection of fuel is prevented for the entire pre-running phase. Furthermore, during the entire pre-running phase, for the inlet valves 18, 19, 20, 21, the valve opening times which overlap the intake stroke and the compression stroke of the associated cylinder 1, 2, 3, 4 are set.

The operating mode is provided for engine starting in the presence of low engine temperatures. The diesel engine has a normal operating temperature which, with regard to a cooling water temperature, typically lies in a range between 70 degrees and 95 degrees. The low engine temperatures for which the operating mode is provided lie below the normal operating temperature. The operating mode is provided in particular for engine starting in the presence of engine temperatures in the case of which the cooling water temperature is below 50 degrees. Furthermore, it is also conceivable to utilize the operating mode for reactivating a cylinder 1, 2, 3, 4 after a cylinder deactivation.

The open-loop and closed-loop control unit 16 is provided so as, in the operating mode, to activate the injection of fuel for the ignition phase for the ignition of the air-fuel mixture. As a result of the activation of the injection during the compression stroke, fuel is injected into the combustion chamber 5, 6, 7, 8 of the corresponding cylinder 1, 2, 3, 4. In conjunction with the combustion air that has been heated in the pre-running phase, an ignitable air-fuel mixture is thus formed in the cylinders 1, 2, 3, 4, which air-fuel mixture ignites during the compression stroke of the corresponding cylinder 1, 2, 3, 4. When all of the cylinders 1, 2, 3, 4 have ignited at least once and the engine rotational speed of the diesel engine has reached the idle rotational speed, the engine starting is complete, and the open-loop and closed-loop control unit 16 switches over into the normal operating mode.

In the illustrated exemplary embodiment, the open-loop and closed-loop control unit 16 is provided so as, during the ignition phase, to set the valve opening times provided for operation in accordance with the Miller cycle. The valve opening times are adjusted to the valve opening times provided for operation in accordance with the Miller cycle before the diesel engine has reached the idle rotational speed. It is however alternatively also conceivable for the open-loop and closed-loop control unit 16 to be provided so as to set the valve opening times provided for operation in accordance with the Miller cycle only once the normal operating mode has been attained. For example, the open-loop and closed-loop control unit 16 may be provided for setting the valve opening times provided for operation in accordance with the Miller cycle when the engine temperature has reached the normal operating temperature. For the normal operating mode, the open-loop and closed-loop control unit 16 is provided so as to set, for the inlet valves 18, 19, 20, 21 assigned to the cylinders 1, 2, 3, 4, valve opening times which completely overlap the exhaust stroke and the intake stroke of the associated cylinder 1, 2, 3, 4.

1-9. (canceled)

10. A diesel engine, in particular high-power diesel engine, comprising: a variable valve drive having an adjustment unit for adjustment of a valve opening time, a valve lift, a camshaft phase angle and/or a valve spread; and an open-loop and/or closed-loop control unit for activation of the adjustment unit, wherein the open-loop and/or closed-loop control unit has at least one operating mode provided for engine starting with presence of low engine temperatures, in which operating mode the open-loop and/or closed-loop control unit is operative, at least during a pre-running phase, to set a valve opening time for at least one inlet valve that at least overlaps a compression stroke of an associated cylinder, and to prevent an injection of fuel at least in the cylinder assigned to the inlet valve.

11. The diesel engine according to claim 10, wherein the open-loop and/or closed-loop control unit is operatively configured to prevent the injection of fuel for at least one cycle.

12. The diesel engine according to claim 10, wherein the open-loop and/or closed-loop control unit is operatively configured, only for the engine starting, to set a valve opening time for the at least one inlet valve that overlaps an intake stroke and the compression stroke of the associated cylinder.

13. The diesel engine according to claim 10, wherein the open-loop and/or closed-loop control unit is operatively configured to set the pre-running phase for at least two cycles.

14. The diesel engine according to claim 10, wherein the open-loop and/or closed-loop control unit is operatively configured, in the operating mode, to activate the injection of fuel for an ignition phase for ignition of an air-fuel mixture in the cylinders.

15. The diesel engine according to claim 10, wherein the adjustment unit is operatively configured to set for the at least one inlet valve a valve opening time that is provided for operation in accordance with a Miller cycle.

16. The diesel engine according to claim 15, wherein the open-loop and/or closed-loop control unit is operatively configured, to set during the ignition phase, the valve opening time provided for operation in accordance with the Miller cycle.

17. The diesel engine according to claim 10, comprising a cylinder power of at least 50 kW and/or a swept volume of at least 1.6 l.

18. A method for starting a diesel engine, in particular for starting a high-power diesel engine, the method comprising, in an operating mode provided for engine starting in presence of low engine temperatures, at least during a pre-running phase, setting a valve opening time for at least one inlet valve that at least overlaps a compression stroke of an associated cylinder, and preventing an injection of fuel at least in the cylinder assigned to the inlet valve using an open-loop and/or closed-loop control unit.
